(19) United States
(12) Patent Application Publication
(10) Pub. No.: US 2005/0280835 A1
(43) Pub. Date: Dec. 22, 2005

(54) Mouse support for a printing device

(76) Inventor: Eric Todd DeBusschere, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/870,101

(22) Filed: Jun. 17, 2004

(51) Int. Cl. B41B 1/00

(52) U.S. Cl. 358/1.1

(57) ABSTRACT

The present invention provides an all-in-one printing device having a housing, a processor disposed within the housing, a printer component mounted in the housing and in communication with the processor, a scanner component mounted in the housing and in communication with the processor, a graphical user interface, such as a liquid crystal display, CRT or organic LED display, mounted on the housing and in communication with the processor, a storage device having instructions for generating a pointer image on the liquid crystal display, and a USB host port adapted to connect to a USB pointing device such as a mouse, the USB host port being in communication with the processor, wherein graphical user interface is adapted to receive commands from the USB pointing device connected to the USB host port to control the pointer image.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to printing devices and, more particularly, to all-in-one printing devices having a user interface.

2. Description of the Related Art

All-in-one (“AIO”) printing devices provide printing, copying, scanning and/or fax capabilities and/or memory card readers in a single unit. AIO devices may be connected to a host computer, such as a personal computer, or may operate in a standalone mode and include a computer (or processor) integral with the device.

Modern standalone AIO devices may include a user interface to facilitate user interaction with the computer system. The user interface bridges the gap between the human user who seeks to control the device and the hardware and/or software that actually controls the device. The user interface may allow a user to navigate menus or select icons that initiate application programs such as spreadsheets, word processing programs, database programs. photo editing programs and the like.

A user interface is typically a numeric keypad, an alphanumeric keyboard or various knobs and/or buttons located on the device. A user interface may also be a graphical user interface such as a monitor, a computer screen, a liquid crystal display (LCD) or the like.

As the complexity of tasks capable of being performed by standalone AIO devices increases, so does the complexity of interfacing with such devices. Accordingly, there is a need for an AIO device that includes a graphical display and a universal serial bus (USB) host port for receiving a USB mouse for facilitating user interface with the AIO device.

### SUMMARY

A first embodiment of the present invention provides an all-in-one printing device having a housing, a processor disposed within the housing, a printer component mounted in the housing and in communication with the processor, a scanner component mounted in the housing and in communication with the processor, a liquid crystal display mounted on the housing and in communication with the processor, a storage device having instructions for generating a pointer image on the liquid crystal display, and a USB host port adapted to connect to a USB pointing device, such as a 2 or 3 button mouse, the USB host port being in communication with the processor, wherein the liquid crystal display is adapted to receive commands from a USB pointing device connected to the USB host port to control the pointer image.

A second embodiment of the present invention provides a method for facilitating user interaction with a multi-function device. The method includes storing, in a storage device mounted in a housing containing a printer component and a scanning component, instructions for generating a pointer image on a graphical user interface mounted on said housing, receiving command instructions from a pointing device connected to a USB host port mounted on said housing to control said pointer image, reading said pointer image generating instructions from said storage device, processing said pointing device command instructions, and actuating said pointer image on said graphical user interface in response to said pointing device command instructions.

Other objects, features and advantages of the present invention will become apparent to those skilled in the art from the detailed description, the accompanying drawings and the appended claims.

### BRIEF DESCRIPTION OF THE DRAWINGS

The invention may be understood with reference to the following drawing:

FIG. 1 is a schematic diagram of a multi-function device according to the present invention.

### DETAILED DESCRIPTION

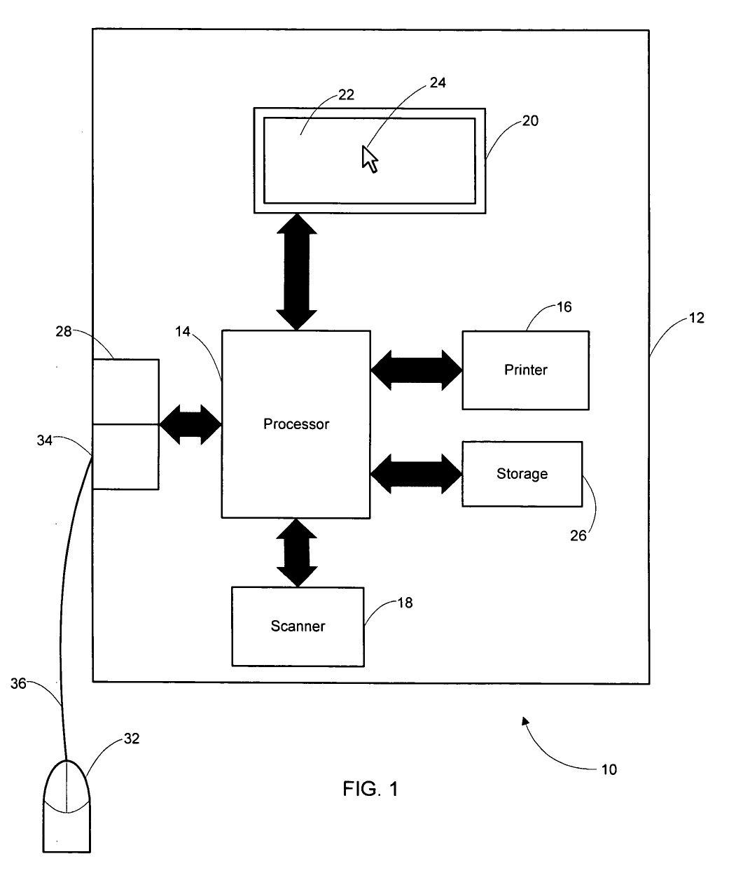

As shown in FIG. 1, a multi-function (or AIO) device of the present invention, generally designated 10, includes a housing 12, a processor 14, a printer component 16, a scanner component 18, a graphical user interface 20, a USB host port 28 and a USB pointing device, such as a 2 button mouse 32.

The processor 14 is disposed within the housing 12 and includes a storage device 26 capable of storing software, data or the like. The storage device can comprise various forms of memory such ROM, RAM or a disk drive. The storage device can also be comprised of a memory card reader and a memory card. Instructions for controlling the graphical user interface 20 display and responding to the mouse 32 can be stored on a memory card, such as an SD card, xD card or Memory Stick card, and then read into an internal storage device 26 or the processor 14. Combinations of these various storage devices can also be used in AIO device 10. Other variations for the storage device are left up to the artisan.

The processor 14 is connected to, and in communication with, the USB host port 28, the graphical user interface 20, the printer component 16 and the scanner component 18 such that the processor 14 may send, receive and process various commands and data for each of the devices connected to or in communication with the processor.

The printer component 16 is mounted in the housing 12 and may be any device capable of marking an image (or indicia) upon a medium such as paper, laminate or the like. Preferably, the printer component 16 is an inkjet printer, a laser printer, a dot-matrix printer, a photo-quality printer or the like, and may be capable of generating black and white images, color images or both.

The scanner component 18 is mounted in the housing 12 and may be any device capable of capturing (scanning) text or images from a document or photograph and translating the text or images into digital form. The scanner component 18 may be a flatbed scanner, a sheet-fed scanner, a film scanner or the like, and may be capable of scanning images in black and white, color or both. The scanner can employ a CIS or CCD scanning mechanism as is known in the art for scanning in images or text.

The graphical user interface 20 can be mounted anywhere on the housing 12 and can include any type of display screen 22 capable of displaying an image as well as text, such as, but not limited to, a liquid crystal display, a color liquid crystal display, a cathode ray tube (CRT) display, a plasma screen, an organic LED display, or the like. The graphical user interface 20 allows a user to visually interact with the device 10 in the same manner as one would visually interact with a personal computer having a monitor.

The USB host port 28 is provided on the housing 12 and is connected to the processor 14 such that a USB mouse 32 can be connected to the USB host port 28 and recognized by the processor 14. The USB host port 28 may be any USB host port commercially available and capable of receiving a standard USB plug within a receiving port 34.

The USB mouse 32 can be any pointing device capable of connecting to the USB host port 28 and sensing and transmitting a relative position signal to the processor 14. For example, the USB mouse 32 can be a standard corded 2 or 3 button desktop mouse 32, with or without a scrolling wheel, connected to the receiving port 34 by a cord 36. Alternatively, the mouse 32 can be a wireless mouse having a transmitter that sends a signal to a receiver that can be plugged into the receiving port 34 of the USB host port 28, an external trackball, a touchpad, combinations of two or more of the forgoing or the like.

The device 10 is provided with software (stored in the storage device 26) capable of using the signals received from the mouse 32 to generate a pointer image 24 (illustrated as an arrow) or cursor on the screen 22. The processor 14 can interpret the mouse commands and translate the commands into viewable actions (such as text or an image) on the graphical user interface 20. The pointer image 24 allows the user to interact with the graphical user interface 20 by, for example, navigating through menus, cropping and editing photographic images, selecting text, and selecting icons.

Accordingly, the present invention provides an AIO device 10 having a USB host port 28 for easily connecting a USB mouse 32 to the device 10 such that a user can view a representation of a scanned image on the color screen 22 and perform complex tasks such as image editing and cropping by manipulating the USB mouse 32. In addition to simplifying complex tasks, the mouse 32, when connected to USB host port 28, can also allow the user to easily and quickly navigate menus, select icons and commands, zoom in on certain areas of an image prior to printing, invert the colors of the image, retouch the image or perform any number of task.

A second embodiment of the present invention provides a method for editing and manipulating images and delivering instructions to the AIO device 10 by moving a USB mouse 32 that sends a signal through the USB host port 28 to the processor 14, which actuates the pointer image 24 and initiates corresponding movement of the pointer image 24 with the movement of the USB mouse 32. By moving the USB mouse 32 and sending mouse command instructions that are visible on the graphical user interface 20, the user can easily manipulate images that have been scanned and print them on the same device.

Although the invention is shown and described with respect to certain embodiments, it is obvious that equivalents and modifications will occur to those skilled in the art upon reading and understanding the specification and the appended claims. The present invention includes all such equivalents and modifications and is limited only by the scope of the claims

1. A multi-function device comprising:
a housing;
a processor disposed within said housing;
a printer component mounted in said housing and in communication with said processor;
a scanner component mounted in said housing and in communication with said processor;
a graphical user interface mounted on said housing and in communication with said processor;
a storage device having instructions for generating a pointer image on said graphical user interface; and
a USB host port adapted to connect to a USB pointing device, said USB host port being in communication with said processor,
wherein said graphical user interface is adapted to receive commands from said USB pointing device connected to said USB host port to control said pointer image.

2. The device of claim 1 wherein said graphical user interface is selected from a group comprised of a liquid crystal display, an organic LED display, a plasma display, a CRT display.

3. The device of claim 2 wherein said graphical user interface is a color display.

4. The device of claim 1 wherein said storage device is selected from a group comprised of ROM memory, RAM memory, disk storage, combination of a memory card reader and memory card, and combinations of two or more of the forgoing devices.

5. The device of claim 1 wherein the USB pointing device is selected from a group comprised of a corded mouse, a wireless mouse, a trackball, a touchpad, and a combination of two or more of the forgoing devices.

6. A system for interfacing with an all-in-one device comprising:
a multi-function device having:
a processor;
a printing component in communication with said processor;
a scanning component in communication with said processor;
a display in communication with said processor;
a USB host port in communication with said processor; and
a USB pointing device connectable to said USB host port for controlling a pointer on said display.

7. The system of claim 6 wherein said multi-function device further comprises a storage device having instructions for generating a pointer image on said display.

8. The system of claim 7 wherein said storage device is selected from a group comprised of ROM memory, RAM memory, disk storage, combination of a memory card reader and memory card, and combinations of two or more of the forgoing devices.

9. The device of claim 6 wherein said display is selected from a group comprised of a liquid crystal display, an organic LED display, a plasma display, and a CRT display.

10. The device of claim 9 wherein said display is a color display.

11. The device of claim 6 wherein the USB pointing device is selected from a group comprised of a corded mouse, a wireless mouse, a trackball, a touchpad, and a combination of two or more of the forgoing devices.

12. A method for facilitating user interaction with a standalone multi-function device, including a storage device, a printer component, a scanning component, a processor, a USB host port connected to a pointing device, and a graphical user interface, comprising:
storing in said storage device instructions for generating a pointer image on said graphical user interface;
receiving command instructions from said pointing device to control said pointer image;
reading said pointer image generating instructions from said storage device;
processing said pointing device command instructions; and
actuating said pointer image on said graphical user interface in response to said mouse command instructions.

13. A method for facilitating user interaction with a multi-function device without a personal computer, the multi-function device including a storage device, a printer component, a scanning component, a processor, a USB host port connected to a mouse, and a graphical user interface, comprising:
receiving command instructions from said mouse to control a pointer image generated on said graphical user interface;
reading pointer image generating instructions from said storage device;
processing said mouse command instructions; and
actuating said pointer image on said graphical user interface in response to said mouse command instructions.

14. The method of claim 13 further comprising the step of storing pointer image generating instructions in said storage device.

15. The method of claim 13 wherein said processing step includes the step of conveying said mouse command instructions from said USB host port to said processor.

16. The method of claim 15 wherein said processing step includes the step of actuating the processor to process said mouse command instructions.
